(19) United States
(12) Patent Application Publication
(10) Pub. No.: US 2020/0201949 A1
(43) Pub. Date: Jun. 25, 2020

(54) INTEGRATED CIRCUIT SYNTHESIS TOOL THAT RESOLVES TIMING PROBLEMS BY AUTOMATICALLY MOVING COMPONENTS BETWEEN LOGIC BLOCKS

(71) Applicant: International Business Machines Corporation, Armonk, NY (US)

(72) Inventors: Lennard Streat, Rancho Cordova, CA (US); Utsav Lokinindi, Folsom, CA (US)

(21) Appl. No.: 16/226,657

(22) Filed: Dec. 20, 2018

(51) Int. Cl. G06F 17/50

(52) U.S. Cl. CPC G06F 17/505; G06F 17/5081; G06F 17/5072

(57) ABSTRACT

An integrated circuit synthesis tool includes a timing problem resolver that automatically moves components between logic blocks in an integrated circuit design to resolve timing problems. Timing results are analyzed to identify timing problems and corresponding components and paths that affect each timing problem. When moving components between logic blocks will improve or eliminate one or more timing problems, the timing issue resolver moves one or more components from an existing logic block into another existing logic block, or into a new logic block. Any changed or new logic blocks are then synthesized, and synthesis of the integrated circuit design resumes in an iterative manner.

### BACKGROUND

### 1. Technical Field

This disclosure generally relates to integrated circuits, and more specifically relates to automated synthesis of integrated circuits.

### 2. Background Art

Integrated circuit design tools continue to evolve and become more powerful. A sample prior art system 100 for integrated circuit design is shown in FIG. 1. A circuit design in a hardware description language (HDL) 100 is provided. The circuit design is initially synthesized by a synthesis tool 110, which determines which circuit components to use to implement the circuit design 100. These components are then placed and interconnections between components are routed on the integrated circuit by the place and route tool 120. Once the placement of components and routing between components by the place and route tool 120 is complete, a timing analysis is performed by the timing analysis tool 130. A test tool 140 then determines whether the timing constraints in the integrated circuit were satisfied in the timing analysis. The results of the test tool 140 are fed back to a debug tool 150, which allows circuit designers to make changes to the design to address the timing issues. The revised design is then input in the synthesis tool 110, and the process continues until all of the timing problems have been resolved. Once the timing problems have all been resolved, the design is ready to be fabricated on a wafer.

Many modern integrated circuits are very complex, and contain billions of components. When working with a large design, responsibilities can be split between different teams of engineers. For example, a chip development team could include a circuit design team, a logic design team, and a pre-silicon validation team. Each team performs different functions during the development of the integrated circuit design. Due to the complexity of many modern designs, it is common to parse a design into smaller logic blocks, sometimes called random logic macros (RLMs) or Macros, for short. These logic blocks are typically prescribed a vertical and planar floor plan, and circuitry for each logic block is synthesized separately from other logic blocks. These logic blocks are then integrated together to complete an integrated circuit design. The synthesis of logic in the logic blocks is typically isolated from the integration of the logic blocks, and these functions may even be performed by separate engineering teams. While parsing a complex design into logic blocks that are synthesized separately reduces the time it takes to produce the final circuit layout, these gains come at a penalty of restricting the placement and routing of block-to-block cones of logic, which makes timing closure for certain paths require manual effort for the logic design and circuit design teams.

### BRIEF SUMMARY

An integrated circuit synthesis tool includes a timing problem resolver that automatically moves components between logic blocks in an integrated circuit design to resolve timing problems. Timing results are analyzed to identify timing problems and corresponding components and paths that affect each timing problem. When moving components between logic blocks will improve or eliminate one or more timing problems, the timing issue resolver moves one or more components from an existing logic block into another existing logic block, or into a new logic block. Any changed or new logic blocks are then synthesized, and synthesis of the integrated circuit design resumes in an iterative manner.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a prior art system for synthesizing an integrated circuit design;

FIG. 2 is a flow diagram of a prior art method that could be used with the system in FIG. 1;

FIG. 3 is a block diagram of a method in accordance with the preferred embodiments for automatically resolving timing problems by moving components between logic blocks;

FIG. 4 is a flow diagram of a method that represents one specific implementation for step 390 in FIG. 3;

FIG. 5 is a block diagram of a computer system that includes a timing problem resolver that can automatically resolve one or more timing problems by moving one or more components between logic blocks;

FIG. 6 is a block diagram showing two sample logic blocks in an integrated circuit design;

FIG. 7 is a block diagram of the logic blocks in FIG. 6 after component C2 has been automatically moved from logic block A to logic block B;

FIG. 8 is a block diagram showing two sample logic blocks in an integrated circuit design;

FIG. 9 is a block diagram of the logic blocks in FIG. 8 after component C7 has been automatically moved from logic block E to logic block D;

FIG. 10 is a block diagram showing two sample logic blocks in an integrated circuit design;

FIG. 11 is a block diagram of the logic blocks in FIG. 10 after adding a new logic block H and after component C10 from logic block F and component C11 in logic block G have been moved to the new logic block H;

FIG. 12 is a block diagram of a more detailed example showing specific components and paths in an integrated circuit design;

FIG. 13 is a timing report showing delays in the components and connections (nets) shown in FIG. 12;

FIG. 14 shows the computation of delay that results in a timing failure in the components shown in FIG. 12;

FIG. 15 is a block diagram showing automatic movement of the gates A0 and A1 from logic block J to a new logic block M, and showing automatic movement of the gates B0 and B1 from logic block K to the new logic block M;

FIG. 16 is a block diagram of logic block M after adding integration flip-flops to address timing issues; and

FIG. 17 is a block diagram of logic block M after adding integration buffers to address timing issues.

### DETAILED DESCRIPTION

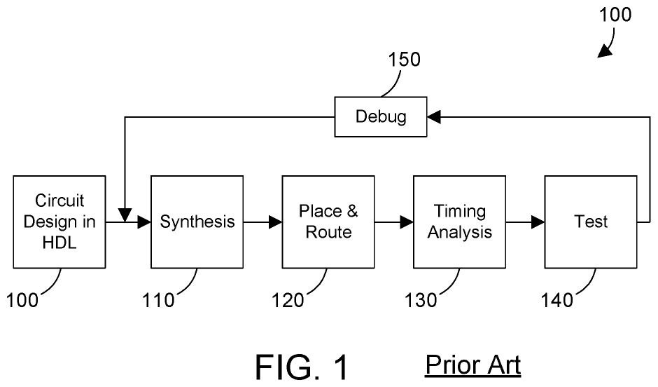

The prior art system 100 in FIG. 1 is generally described above in the Background Art section. Method 200 is a prior art method for synthesis of an integrated circuit design that could happen, for example, on the prior art system 100 in FIG. 1. The integrated circuit design is parsed into logic blocks (step 210). Each logic block is synthesized, preferably by generating a netlist for each logic block (step 220), which produces individual netlists for all logic blocks 222. The components are then placed within each logic block (step 230), and the logic blocks are integrated by interconnecting the logic blocks and adding interconnection circuitry to meet desired timing (step 240). The result is a single netlist that includes all logic blocks 250. Timing analysis on the resulting design is then performed (step 260). When there are more timing problems that can be automatically resolved (step 270=YES), method 200 loops back to step 230 and continues, making potentially many iterations that each address different timing problems that appear in the timing analysis. Once there are no more timing problems that can be automatically resolved (step 270=NO), if there still remaining timing problems (step 280=NO), this begins a manual process where engineers determine changes to logic blocks, placement and routing (step 290) to address the remaining timing problems. Once the engineers make the appropriate changes in step 290, these changes are reflected in updated netlists for the logic blocks 222. Method 200 continues to loop back and iterate as long as all the timing problems have not been resolved (step 280=NO), and this continues until all timing problems are resolved (step 280=YES). At this point, method 200 is done.

An integrated circuit synthesis tool includes a timing problem resolver that automatically moves components between logic blocks in an integrated circuit design to resolve timing problems. Timing results are analyzed to identify timing problems and corresponding components and paths that affect each timing problem. When moving components between logic blocks will improve or eliminate one or more timing problems, the timing issue resolver moves one or more components from an existing logic block into another existing logic block, or into a new logic block. Any changed or new logic blocks are then synthesized, and synthesis of the integrated circuit design resumes in an iterative manner.

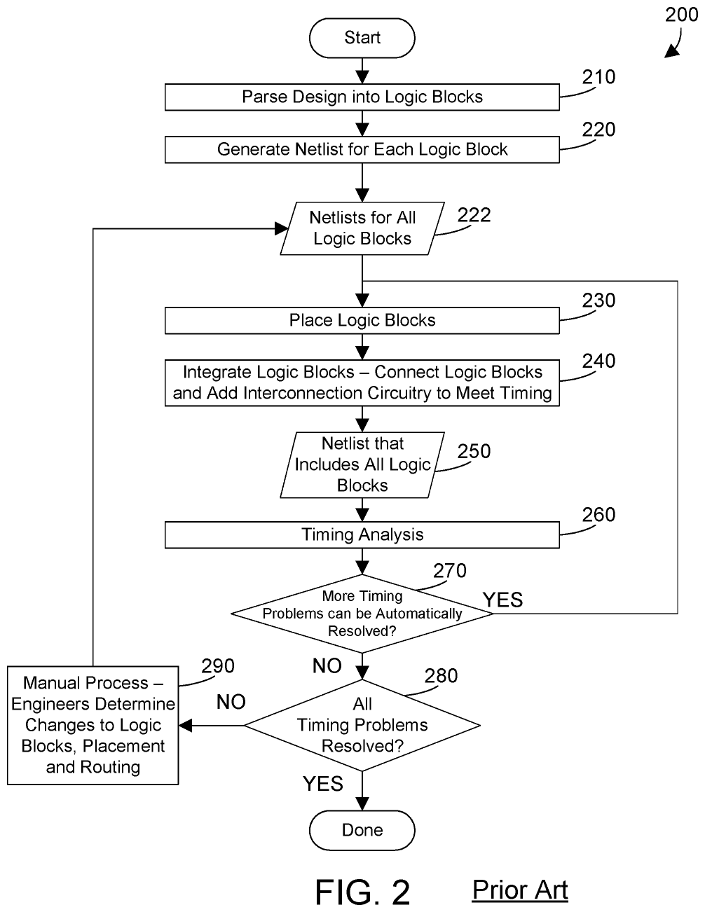

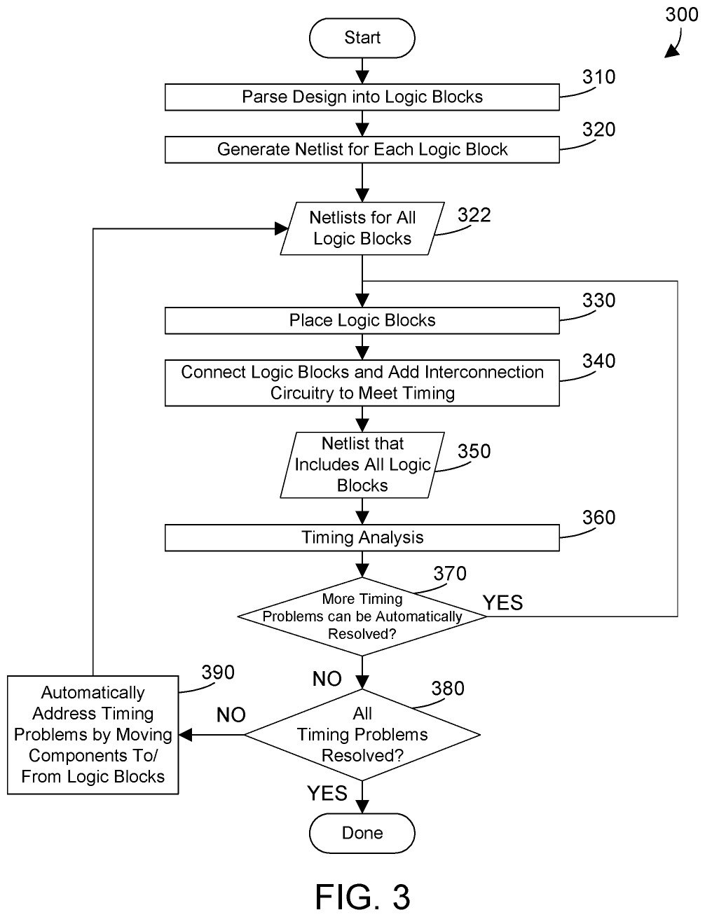

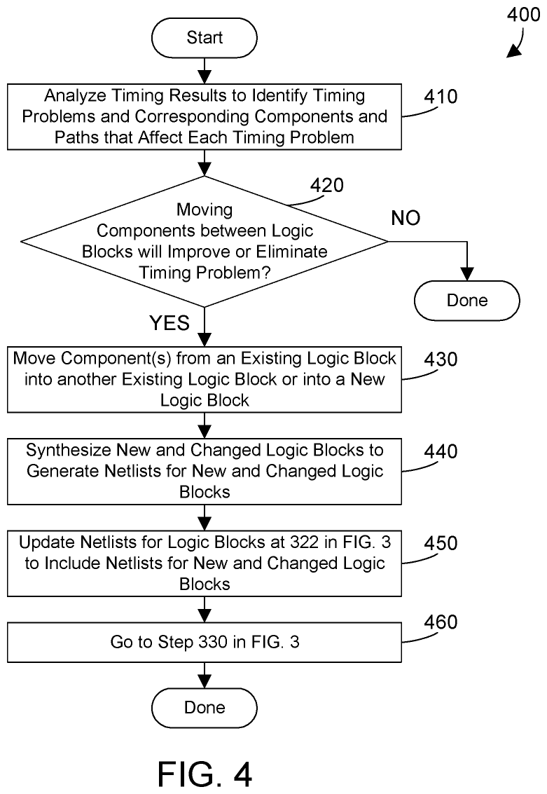

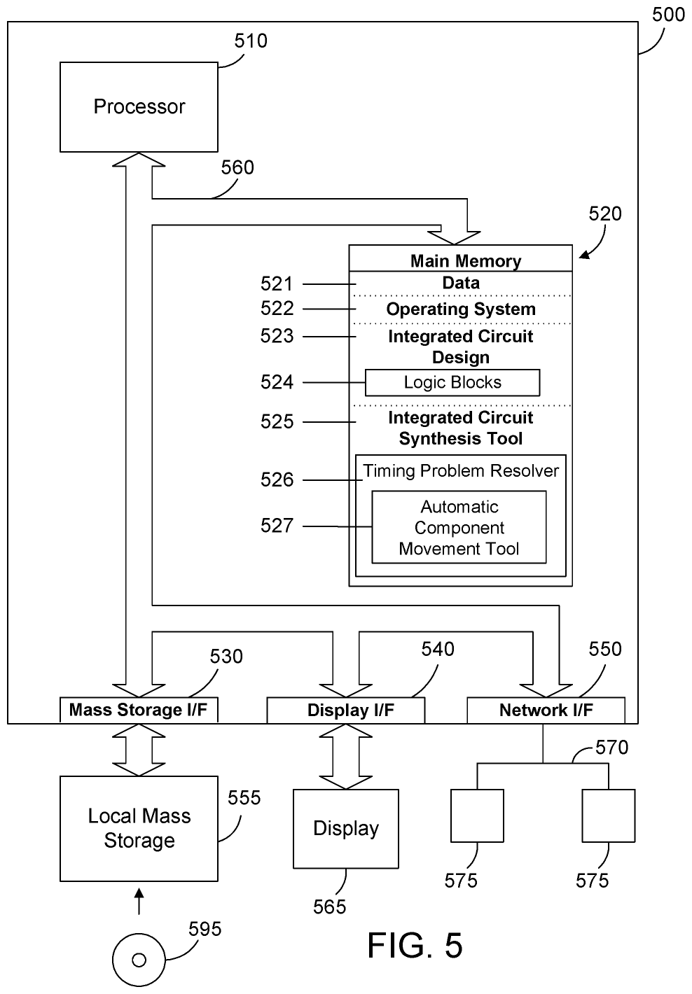

Method 300 represents steps preferably performed by an integrated circuit synthesis tool, such as 525 in FIG. 5. Note that steps 310, 320, 330, 340, 360, 370 and 380 could be the same as corresponding prior art steps 210, 220, 230, 240, 260, 270 and 280, respectively, as discussed above with reference to FIG. 2. However, it is equally within the scope of the disclosure and claims herein for one or more of these steps to include functionality that is not in the prior art steps in FIG. 2. Netlists for all logic blocks 322 include netlists for each of the individual logic blocks, including those automatically changed or created in step 390. Netlist that includes all logic blocks 350 is a netlist that has not only the logic blocks, but also includes the connections between logic blocks. In FIG. 3, when there are no more timing problems that can be automatically resolved (step 370=NO), and when not all timing problems have been resolved (step 380=NO), instead of entering a manual step like 290 in FIG. 2 where engineers have to manually make changes to the integrated circuit design, the integrated circuit synthesis tool instead addresses one or more timing problems by automatically moving components to and from logic blocks in the design. In known systems, the boundaries of the logic blocks are hard boundaries that the synthesis tool cannot cross. This is why engineers must perform the manual steps represented in step 290 in FIG. 2. The disclosure and claims herein improve upon the prior art by automatically resolving timing problems by moving components across the boundaries of logic blocks. The moving of components in step 390 can be between existing logic blocks in the integrated circuit design, or could be between an existing logic block and a new logic block created during step 390 to resolve a timing problem. The moving of components from one logic block to another results in two logic blocks that were not in the original netlists for all logic blocks 322. As a result, step 390 synthesizes any changed and new logic blocks to generate corresponding netlists, and adds these netlists to the netlists for all logic blocks 322. Method 300 may then continue its work using the modified and new netlists, allowing the method 300 to continue iterating to resolve many timing problems that would normally have to be resolved manually by engineers, such as shown in step 290 in FIG. 2. The integrated circuit synthesis tool thus provides a greater level of automation in generating the integrated circuit design than was possible in the prior art.

FIG. 4 shows a method 400 that is one suitable implementation for step 390 shown in FIG. 3. The timing results are analyzed to identify timing problems and corresponding components and paths that affect each timing problem (step 410). When moving components between logic blocks will not improve or eliminate a timing problem (step 420=NO), method 400 is done. When moving components between logic blocks will improve or eliminate one or more timing problems (step 420=YES), components in an existing logic block may be moved to another existing logic block or into a newly-created logic block (step 430). All new and changed logic blocks are synthesized to generate netlists for the new and changed logic blocks (step 440). The netlists for all logic blocks 322 in FIG. 3 is then updated to include the netlists for any new and changed logic blocks (step 450). Control is then passed to step 330 in FIG. 3 (step 460), allowing method 300 to continue iterating to resolve timing problems.

Referring to FIG. 5, a computer system 500 is one suitable implementation of a computer system that includes an integrated circuit synthesis tool as described herein. Computer system 500 is an IBM POWER9 computer system. However, those skilled in the art will appreciate that the disclosure herein applies equally to any computer system, regardless of whether the computer system is a complicated multi-user computing apparatus, a single user workstation, a laptop computer system, a tablet computer, a phone, or an embedded control system. As shown in FIG. 5, computer system 500 comprises one or more processors 510, a main memory 520, a mass storage interface 530, a display interface 540, and a network interface 550. These system components are interconnected through the use of a system bus 560. Mass storage interface 530 is used to connect mass storage devices, such as local mass storage device 555, to computer system 500. One specific type of local mass storage device 555 is a readable and writable CD-RW drive, which may store data to and read data from a CD-RW 595. Another suitable type of local mass storage device 555 is a card reader that receives a removable memory card, such as an SD card, and performs reads and writes to the removable memory. Yet another suitable type of local mass storage device 555 is universal serial bus (USB) that reads a storage device such as a flash drive.

Main memory 520 preferably contains data 521, an operating system 522, an integrated circuit design 523 that includes a plurality of logic blocks 524, and an integrated circuit synthesis tool 525. Data 521 represents any data that serves as input to or output from any program in computer system 500. Operating system 522 is a multitasking operating system, such as AIX or LINUX. The integrated circuit design 523 includes a plurality of logic blocks 524, which are blocks of components in the integrated circuit design that are treated as a group. Thus, each of the logic blocks 524 is preferably synthesized separately from the other logic blocks. The logic blocks 524 may be in a high-level form, such as in hardware description language, or could be in a lower-level form, such as a netlist that specifies all components and connections in a logic block. Examples of suitable logic blocks include Random Logic Macros (RLMs), or other units that are sometimes called “hard IP” in an integrated circuit design.

The integrated circuit synthesis tool 525 performs synthesis of portions of the integrated circuit design 523, including synthesis of the individual logic blocks 524. The integrated circuit synthesis tool 525 includes a timing problem resolver 526 that includes an automatic component movement tool 527 that automatically moves components between logic blocks to resolve timing problems. While the automatic component movement tool 527 is shown in FIG. 5 to conceptually illustrate the functionality of moving components between logic blocks to resolve timing problems, the functions of the automatic component movement tool 527 are discussed herein as being performed by the timing problem resolver 526.

Computer system 500 utilizes well known virtual addressing mechanisms that allow the programs of computer system 500 to behave as if they only have access to a large, contiguous address space instead of access to multiple, smaller storage entities such as main memory 520 and local mass storage device 555. Therefore, while data 521, operating system 522, integrated circuit design 523, and integrated circuit synthesis tool 525 are shown to reside in main memory 520, those skilled in the art will recognize that these items are not necessarily all completely contained in main memory 520 at the same time. It should also be noted that the term “memory” is used herein generically to refer to the entire virtual memory of computer system 500, and may include the virtual memory of other computer systems coupled to computer system 500.

Processor 510 may be constructed from one or more microprocessors and/or integrated circuits. Processor 510 executes program instructions stored in main memory 520. Main memory 520 stores programs and data that processor 510 may access. When computer system 500 starts up, processor 510 initially executes the program instructions that make up operating system 522. Processor 510 also executes the integrated circuit synthesis tool 525.

Although computer system 500 is shown to contain only a single processor and a single system bus, those skilled in the art will appreciate that an integrated circuit synthesis tool as described herein may be practiced using a computer system that has multiple processors and/or multiple buses. In addition, the interfaces that are used preferably each include separate, fully programmed microprocessors that are used to off-load compute-intensive processing from processor 510. However, those skilled in the art will appreciate that these functions may be performed using I/O adapters as well.

Display interface 540 is used to directly connect one or more displays 565 to computer system 500. These displays 565, which may be non-intelligent (i.e., dumb) terminals or fully programmable workstations, are used to provide system administrators and users the ability to communicate with computer system 500. Note, however, that while display interface 540 is provided to support communication with one or more displays 565, computer system 500 does not necessarily require a display 565, because all needed interaction with users and other processes may occur via network interface 550.

Network interface 550 is used to connect computer system 500 to other computer systems or workstations 575 via network 570. Computer systems 575 represent computer systems that are connected to the computer system 500 via the network interface. Network interface 550 broadly represents any suitable way to interconnect electronic devices, regardless of whether the network 570 comprises present-day analog and/or digital techniques or via some networking mechanism of the future. Network interface 550 preferably includes a combination of hardware and software that allows communicating on the network 570. Software in the network interface 550 preferably includes a communication manager that manages communication with other computer systems 575 via network 570 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 550. In one suitable implementation, the network interface 550 is a physical Ethernet adapter.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

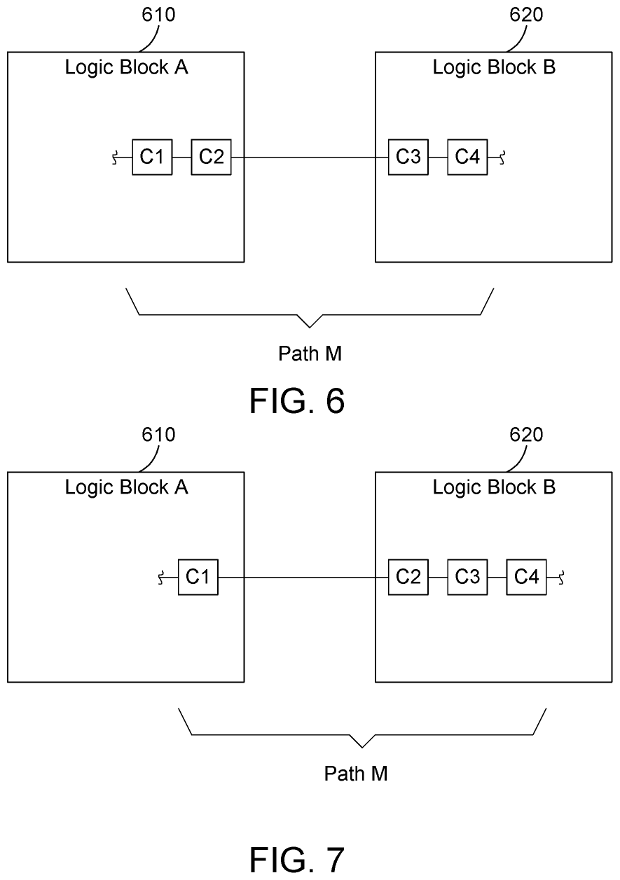

FIGS. 6-17 illustrate some examples of moving components between logic blocks as described and claimed herein. Referring to FIG. 6, a logic block A 610 has components C1 and C2, and logic block B 620 has components C3 and C4. These logic blocks 610 and 620 also include other components that are not relevant to the discussion herein. The components in the logic blocks 610 and 620 can be individual digital electronic components, such as gates, inverters, flip-flops, etc., or could be groupings of multiple of these electronic components. Component C2 in logic block A 610 is connected to component C3 in logic block B 620 as shown in FIG. 6. We assume the path M that includes C1, C2, C3 and C4 is a critical path that has a timing problem. A “timing problem” as used herein occurs when a path in the integrated circuit design has signal timing characteristics that do not satisfy desired timing constraints. A timing problem can thus be alternatively called a timing failure because a timing problem occurs in a path when the path fails to provide the desired signal timing characteristics.

We assume for this example in FIG. 6 the timing results of the timing analysis in step 360 in FIG. 3 identifies path M as having a timing problem (step 410 in FIG. 4). We further assume that moving component C2 from logic block A 610 to logic block B 620 will improve or eliminate a timing problem (step 420=YES). Heuristics for determining the component movement policy take into account the process technology characteristics. The timing problem resolver 526 in FIG. 5 then moves component C2 from logic block A 610 to logic block B 620, as shown in FIG. 7. In the prior art, the logic blocks provide hard boundaries that an integrated circuit synthesis tool cannot cross in terms of moving components without significant manual effort. The invention disclosed and claimed herein provides more flexibility by providing the ability to automatically and strategically move components between logic blocks, thereby automating the solving of a much larger number of timing problems. Once component C2 has been moved from logic block A 610 to logic block B 620, the timing problem resolver synthesizes, or causes the synthesis of, the two modified logic blocks 610 and 620, to generate new netlists for these modified logic blocks. These new netlists for the modified logic blocks are then used to replace the old netlists for the two original logic blocks at 322 in FIG. 3, and synthesis then continues.

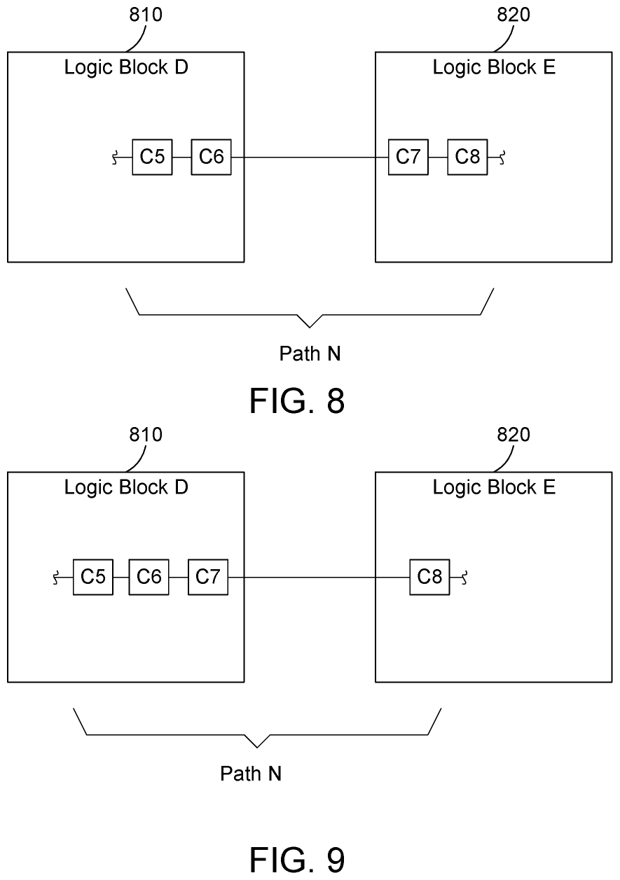

Referring to FIG. 8, we assume the results of the timing analysis in step 360 in FIG. 6 identifies path N as having a timing problem (step 410 in FIG. 4). We further assume that moving component C7 from logic block E 820 to logic block D 810 will improve or eliminate a timing problem (step 420=YES). The timing problem resolver 526 in FIG. 5 then moves component C7 from logic block E 820 to logic block D 810, as shown in FIG. 9. Once component C7 has been moved from logic block E 820 to logic block D 810, the timing problem resolver synthesizes, or causes the synthesis of, the two modified logic blocks 810 and 820, to generate new netlists for these modified logic blocks. These new netlists for the modified logic blocks are then used to replace the old netlists for the two original logic blocks at 322 in FIG. 3, and synthesis then continues.

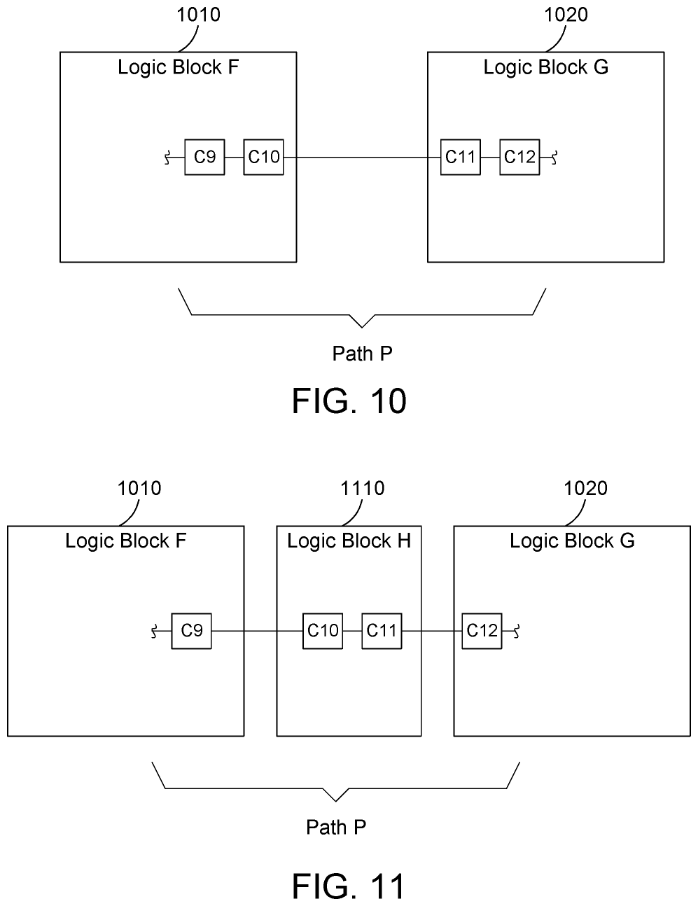

FIGS. 6-10 illustrate moving a component from one existing logic block to another adjacent and existing logic block. Note, however, the timing problem resolver 526 can additionally create one or more new logic blocks, and move one or more components from one or more existing logic blocks to the new logic block(s). Such an example is shown in FIGS. 10 and 11. Referring to FIG. 10, we assume the timing results of the timing analysis in step 360 in FIG. 6 identifies path P as having a timing problem (step 410 in FIG. 4). We further assume that moving component C10 from logic block F 1010 and component C11 from logic block G 1020 into a new logic block will improve or eliminate a timing problem (step 420=YES). The timing problem resolver 526 in FIG. 5 then creates a new logic block H 1110 shown in FIG. 11, and moves the component C10 from logic block F 1010 to logic block H 1110, and moves the component C11 from logic block G 1020 to logic block H 1110, as shown in FIG. 11. Once components C10 and C11 are moved to logic block H 1110, the timing problem resolver synthesizes, or causes the synthesis of, the two modified logic blocks 1010 and 1020, as well as the new logic block H 1110, to generate new netlists for the two modified blocks, and to generate a netlist for the new logic block H 1110. The new netlists for the modified logic blocks are then used to replace the old netlists for the two original logic blocks at 322 in FIG. 3, and the new netlist for the new logic block is added to the logic blocks at 322 in FIG. 3, and synthesis then continues.

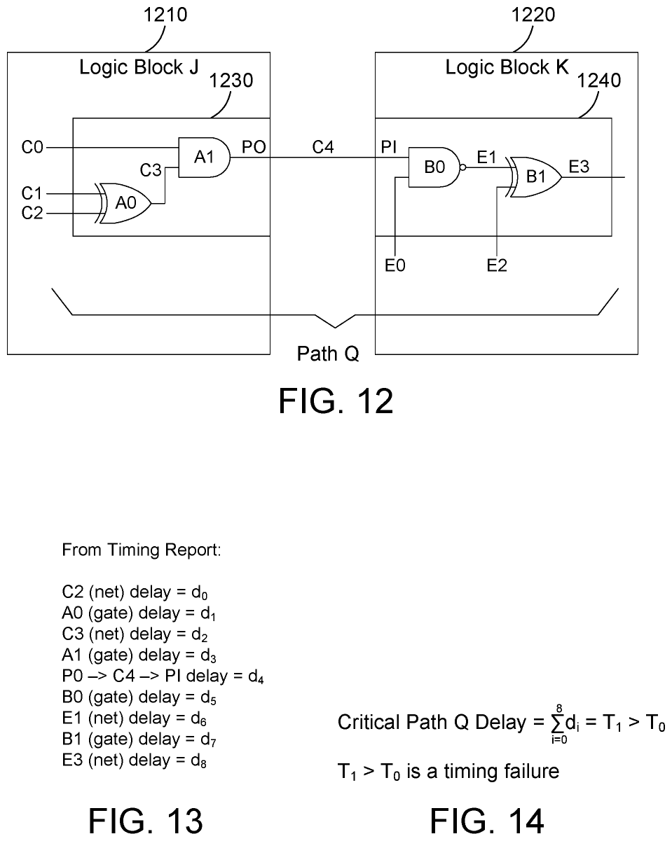

A more detailed example is now presented in FIGS. 12-17 to illustrate the concepts discussed generally above in the example in FIGS. 10 and 11. We assume two logic blocks 1210 and 1220 are connected as shown in FIG. 12. Logic block J 1210 includes a block of circuitry 1230 that includes an exclusive OR (XOR) gate A0 and an AND gate A1. The XOR gate A1 has two inputs C1 and C2 that come from other components in logic block J 1210. The AND gate A1 has two inputs, a first C0 that comes from another component in logic block J 1210 and a second C3 that comes from the output of the XOR gate A0. The output of the AND gate A1 goes to a Pin Out (PO) on logic block J 1210, which is connected via connection C4 to a Pin In (PI) on a block of circuitry 1240 in logic block K 1220. The PI input goes to one of the inputs on a NAND gate B0, with the other input E0 coming from another component in logic block K 1220. The output of the NAND gate B0 is a signal E1 that goes to an input on an XOR gate B1, with the other input E2 coming from another component in logic block K 1220.

We assume the timing report includes the delays shown in FIG. 13. The analysis of the timing report allows determining critical timing paths, and the associated nets and components for each critical path. Thus, the analysis in FIG. 13 shows the delays for what is determined to be a critical path, which is shown in FIG. 12 by the darkened lines. Other delays not in the critical path are not shown in FIG. 13 for the sake of convenience. The total delay across the critical path Q is the sum of the delays shown in FIG. 13, which we assume for this example equals T1, which is greater than T0, the desired time for path Q. The result is T1>T0, which is a timing failure, or timing problem, as shown in FIG. 14. We further assume the timing problem for path Q can be reduced or eliminated by moving the components in blocks of circuitry 1230 and 1240 to a new logic block.

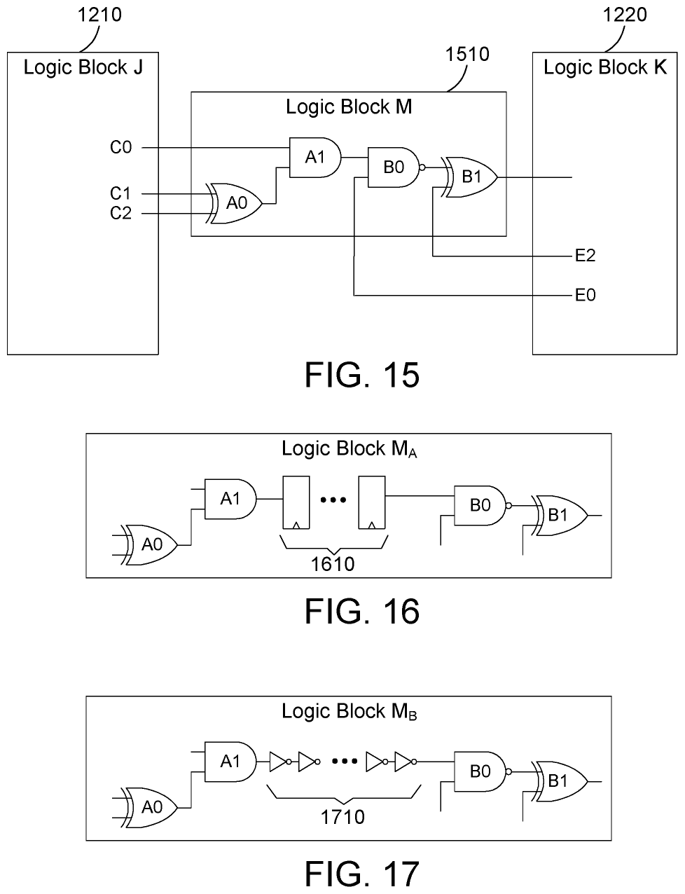

A new logic block M 1510 is created, and the logic in the two blocks 1230 and 1240 in FIG. 12 are moved to the new logic block 1510, as shown in FIG. 15. The two changed logic blocks 1210 and 1220, along with the newly-generated logic block 1510, are then synthesized. The result is netlists for logic blocks J 1210 and K 1220 that are used to replace the prior netlists in the netlists for all logic blocks 322 in FIG. 3, and a new netlist for logic block M 1510 that is added to the netlists for all logic blocks 322. With these modified and new netlists for these three logic blocks, the synthesis steps can continue, such as at step 330 in FIG. 3. In step 340, interconnection circuitry may be added to meet timing. Suitable examples of interconnection circuitry that could be added in step 340 include one or more flip-flops 1610 as shown in FIG. 16, and one or more inverters or buffers 1710 as shown in FIG. 17.

While logic block H 1110 in FIG. 11 and logic block M 1510 in FIG. 15 are shown as logic blocks similar to the adjacent logic blocks that have hard boundaries for their components, it is equally within the scope of the disclosure and claims herein for the newly-created logic block to be an integration-scope wrapper that does not have fixed dimensions, and that floats within the integration scope. Thus, a newly-created logic block could be a logic block similar to the other logic blocks in the design, or could be an integration-scope wrapper.

The invention disclosed herein allows automated moving of components in an integrated circuit design across logic block boundaries, thereby allowing the integrated circuit synthesis tool to automatically take care of many more timing problems than was possible in the prior art.

The disclosure and claims herein support an apparatus comprising: at least one processor; a memory coupled to the at least one processor; an integrated circuit design residing in the memory, wherein the integrated circuit design comprises a plurality of logic blocks that includes a first logic block coupled to a second logic block; and an integrated circuit synthesis tool residing in the memory and executed by the at least one processor that synthesizes each of the plurality of logic blocks before determining placement of the plurality of logic blocks on a floorplan of the integrated circuit, the integrated circuit tool placing the plurality of logic blocks and routing connections between the plurality of logic blocks, and after the placing and routing is complete, the integrated circuit synthesis tool uses a timing issue resolver to analyze timing results, wherein the timing issue resolver comprises an automatic component movement tool that modifies the first logic block by automatically moving at least one component in the first logic block to a third logic block, then synthesizes the modified first logic block and the third logic block, then continues synthesis of the integrated circuit design using the modified first logic block and the third logic block.

The disclosure and claims herein further support an apparatus comprising: at least one processor; a memory coupled to the at least one processor; an integrated circuit design residing in the memory, wherein the integrated circuit design comprises a plurality of logic blocks that includes a first logic block coupled to a second logic block; and an integrated circuit synthesis tool residing in the memory and executed by the at least one processor that synthesizes each of the plurality of logic blocks by creating a netlist for each of the plurality of logic blocks before determining placement of the plurality of logic blocks on a floorplan of the integrated circuit, the integrated circuit tool placing the plurality of logic blocks and routing connections between the plurality of logic blocks, and after the placing and routing is complete, the integrated circuit synthesis tool uses a timing issue resolver to analyze timing results that include a plurality of timing failures, wherein the timing issue resolver comprises an automatic component movement tool that modifies the first logic block and the second logic block by automatically moving at least one component in the first logic block to the second logic block, that automatically creates a new logic block, and that modifies a third of the plurality of logic blocks by automatically moving at least one component in the third logic block to the new logic block, then synthesizes the modified first logic block, the modified second logic block, the modified third logic block, and the new logic block, then continues synthesis of the integrated circuit design using the modified first logic block, the modified second logic block, and modified third logic block, and the new logic block, wherein movement of the at least one component improves at least one of the plurality of timing failures, wherein the timing issue resolver iterates, moving one or more components between the plurality of logic blocks in the integrated circuit design, and between the plurality of logic blocks in the integrated circuit design and newly-created logic blocks added to the integrated circuit design, to automatically address multiple of the plurality of timing failures in the timing results.

The disclosure and claims herein additionally support a computer-implemented method executed by at least one processor for synthesizing an integrated circuit design, the method comprising: parsing the integrated circuit design into a plurality of logic blocks that includes a first logic block coupled to a second logic block; synthesizing each of the plurality of logic blocks; placing all of the plurality of logic blocks; connecting the plurality of logic blocks with a plurality of interconnections; performing a timing analysis that produces timing results; analyzing the timing results to identify a plurality of timing failures; modifying the first logic block by automatically moving at least one component in the first logic block to a third logic block; synthesizing the modified first logic block and the third logic block; and continuing synthesis of the integrated circuit design using the modified first logic block and the third logic block.

An integrated circuit synthesis tool includes a timing problem resolver that automatically moves components between logic blocks in an integrated circuit design to resolve timing problems. Timing results are analyzed to identify timing problems and corresponding components and paths that affect each timing problem. When moving components between logic blocks will improve or eliminate one or more timing problems, the timing issue resolver moves one or more components from an existing logic block into another existing logic block, or into a new logic block. Any changed or new logic blocks are then synthesized, and synthesis of the integrated circuit design resumes in an iterative manner.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
an integrated circuit design residing in the memory, wherein the integrated circuit design comprises a plurality of logic blocks that includes a first logic block coupled to a second logic block; and
an integrated circuit synthesis tool residing in the memory and executed by the at least one processor that synthesizes each of the plurality of logic blocks before determining placement of the plurality of logic blocks on a floorplan of an integrated circuit, the integrated circuit tool placing the plurality of logic blocks and routing connections between the plurality of logic blocks, and after the placing and routing is complete, the integrated circuit synthesis tool uses a timing issue resolver to analyze timing results, wherein the timing issue resolver comprises an automatic component movement tool that modifies the first logic block by automatically moving at least one component in the first logic block to a third logic block, then synthesizes the modified first logic block and the third logic block, then continues synthesis of the integrated circuit design using the modified first logic block and the third logic block, wherein the third logic block comprises a new logic block created by the timing issue resolver that is placed between the first logic block and the second logic block.

2. The apparatus of claim 1 wherein the third logic block comprises the second logic block, modified by the movement of the at least one component from the first logic block to the second logic block.

3. (canceled)

4. The apparatus of claim 1 wherein the timing results include a plurality of timing failures.

5. The apparatus of claim 4 wherein movement of the at least one component improves at least one of the plurality of timing failures.

6. The apparatus of claim 4 wherein the timing issue resolver iterates, moving one or more components between the plurality of logic blocks in the integrated circuit design, and between the plurality of logic blocks in the integrated circuit design and newly-created logic blocks added to the integrated circuit design, to automatically address multiple of the plurality of timing failures in the timing results.

7. The apparatus of claim 1 wherein the integrated circuit synthesis tool synthesizes the plurality of logic blocks by creating a netlist for each of the plurality of logic blocks.

8. The apparatus of claim 1 wherein the timing issue resolver synthesizes the modified first logic block and the third logic block by generating a netlist for the modified first logic block and by generating a netlist for the third logic block.

9. An apparatus comprising:
at least one processor;
a memory coupled to the at least one processor;
an integrated circuit design residing in the memory, wherein the integrated circuit design comprises a plurality of logic blocks that includes a first logic block coupled to a second logic block; and
an integrated circuit synthesis tool residing in the memory and executed by the at least one processor that synthesizes each of the plurality of logic blocks by creating a netlist for each of the plurality of logic blocks before determining placement of the plurality of logic blocks on a floorplan of the integrated circuit, the integrated circuit tool placing the plurality of logic blocks and routing connections between the plurality of logic blocks, and after the placing and routing is complete, the integrated circuit synthesis tool uses a timing issue resolver to analyze timing results that include a plurality of timing failures, wherein the timing issue resolver comprises an automatic component movement tool that modifies the first logic block and the second logic block by automatically moving at least one component in the first logic block to the second logic block, that automatically creates a new logic block, and that modifies a third of the plurality of logic blocks by automatically moving at least one component in the third logic block to the new logic block, then synthesizes the modified first logic block, the modified second logic block, the modified third logic block, and the new logic block, then continues synthesis of the integrated circuit design using the modified first logic block, the modified second logic block, and modified third logic block, and the new logic block, wherein movement of the at least one component improves at least one of the plurality of timing failures, wherein the timing issue resolver iterates, moving one or more components between the plurality of logic blocks in the integrated circuit design, and between the plurality of logic blocks in the integrated circuit design and newly-created logic blocks added to the integrated circuit design, to automatically address multiple of the plurality of timing failures in the timing results.

10. The apparatus of claim 9 wherein the timing issue resolver synthesizes the modified first logic block and the third logic block by generating a netlist for the modified first logic block and by generating a netlist for the third logic block.

11. A computer-implemented method executed by at least one processor for synthesizing an integrated circuit design, the method comprising:
parsing the integrated circuit design into a plurality of logic blocks that includes a first logic block coupled to a second logic block;
synthesizing each of the plurality of logic blocks;
placing all of the plurality of logic blocks;
connecting the plurality of logic blocks with a plurality of interconnections;
performing a timing analysis that produces timing results;
analyzing the timing results to identify a plurality of timing failures;
modifying the first logic block by automatically moving at least one component in the first logic block to a third logic block, wherein the third logic block comprises a new logic block that is placed between the first logic block and the second logic block;
synthesizing the modified first logic block and the third logic block; and
continuing synthesis of the integrated circuit design using the modified first logic block and the third logic block.

12. The method of claim 11 wherein the third logic block comprises the second logic block, modified by the movement of the at least one component from the first logic block to the second logic block.

13. (canceled)

14. The method of claim 11 wherein movement of the at least one component improves at least one of the plurality of timing failures.

15. The method of claim 11 further comprising iterating, moving one or more components between the plurality of logic blocks in the integrated circuit design, and between the plurality of logic blocks in the integrated circuit design and newly-created logic blocks added to the integrated circuit design, to automatically address multiple of the plurality of timing failures in the timing results.

16. The method of claim 11 wherein synthesizing each of the plurality of logic blocks comprises creating a netlist for each of the plurality of logic blocks.

17. The method of claim 11 wherein synthesizing the modified first logic block and the third logic block comprises generating a netlist for the modified first logic block and by generating a netlist for the third logic block.
